(19) United States
(12) Patent Application Publication
(10) Pub. No.: US 2002/0052887 A1
(43) Pub. Date: May 2, 2002

(54) Method and system for distributing master file

(75) Inventor: Shigeo Mori, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/983,263

(22) Filed: Oct. 23, 2001

(30) Foreign Application Priority Data
Oct. 30, 2000 (JP) 2000-329983

(51) Int. Cl. G06F 12/00

(52) U.S. Cl. 707/201

(57) ABSTRACT

A center master file group 29 is unitarily administered and kept updated to be the latest data, and a master distributing-side program 21 provides information that updating has taken place to a user terminal 10 receiving the service whenever a master file in the center master file group 29 is updated, distributes data of the updated master file to the user terminal 10 upon a request from the user in need of that master file, and registers the information in a user management file 28 to automatically charge a service rate for the distribution, wherein the user terminal 10 updates its master file group 19 with the data of the updated master file distributed by the master distributing-side program 21.

### FIELD OF THE INVENTION

The present invention relates to a network system where data (e.g., messages for business transaction) is exchanged between users (e.g., companies) via a network such as the Internet by referring to a master file. More particularly, the present invention relates to a system and a method for distributing an updated master file to the users so that the users can follow up with master file updating.

### BACKGROUND OF THE INVENTION

Generally, in exchanging data between users (e.g., exchanging data for business transaction) by using a network, attributes of data items and code information of the data to be exchanged are predetermined and defined in a master file which is referred to by the shared users for information exchange.

In a conventional master file distributing system (a system for distributing an updated master file as soon as the master files are updated), the updated master file is distributed to all of the users even when the updated master file is only relative to specific users. If the master file is updated frequently, the file (the updated master file) needs to be frequently transferred from a master file administration server to the user terminals.

According to the above-described master file distributing system, the updated master file is distributed to every user even when the updated master file concerns only part of the users. In this case, if the updating takes place frequently, the consequent frequent file transfer will cause an increase of charged usage of line, an increase in the network traffics and an increase of the load put on the user terminal machines. Due to these problems, master file distribution business through charging and collecting rate in return for the service has not been established in good conditions.

### SUMMARY OF THE INVENTION

In view of the above-described problems, the present invention has an objective of providing a system and a method for distributing a master file, wherein a group of master files necessary for a transaction among a plurality of users (e.g., companies) is unitarily administrated by a center (a master administration center). Whenever a master file is updated, a notice of updating is sent to the users pre-registered at the center, and the master file is sent to the user only upon a user's request, whereby a rate is collected from that user. Specifically, the system and the method for distributing a master file according to the present invention can, in view of the problems associated with the conventional master file administration and distribution, establish a business model for distributing the master files only to users who are in need of those master files and collecting rates in return for the distribution.

Examples of publications relating to prior art of the master file distributing system of the present invention include JP-A-08-022409 and JP-A-11-238009 which are similar to the invention in that they concern data distribution via a network.

The techniques described in the above-mentioned publications (“System for administering distribution information through network” and “Method and system for controlling module distribution”), however, are both related to a technique of differential distribution of data (module/information) and differs from the present invention that belongs to a category of business model (the present invention does not concern a technique of differential distribution of files but has a business aspect of “administrating charge information for appropriately collecting a rate in return for a master file distribution service”).

A system according to the present invention for distributing a master file in a network system where a group of user terminals that mutually exchange data based on master files and a master administration center for unitarily administering a group of master files used by the user terminals are connected, comprises: a group of center master files at the master administration center which are kept updated to be the latest master file group; a user management file at the master administration center for managing information related to the users receiving the master file distribution service; a user's registration controlling means at the master administration center for registering subscriber's registration information in the user management file based on an application for a subscriber's registration from the user terminal and for distributing a master distributed-side program to the user terminal to be installed in the user terminal; an updating information providing means at the master administration center for providing information that updating has taken place to the user receiving the service (who has registered as a subscriber to the master file distribution service) whenever a master file in the center master file group is updated; a master distributed-side program at the user terminal, which is activated in response to an updating request from the user who judges based on the information given by the updating information providing means (in response to an instruction from the user requesting updating, who considers updating of the master file in the master file group of his(her) user terminal necessary), which acquires versions of all of the master files in the master file group of the user terminal, which notifies the master administration center the version information, which updates the master file group of the user terminal by expanding compressed file data sent from the master administration center in response to the notice, and which sends an updating complete notice to the master administration center as soon as the updating is complete; and a master file distribution controlling means at the master administration center, which extracts a master file in the center master file group whose version mismatches with that of the corresponding master file in the master file group of the user terminal based on the version information sent from the user terminal, which sends compressed file data of the extracted master file to the user terminal, and which registers distribution information and charge information (information for automatically charging a service rate in return for each master file distribution) in the user management file based on the updating complete notice from the user terminal.

A system according to the present invention for distributing a master file in a network system where a group of user terminals that mutually exchange data based on master files and a master administration center for unitarily administering a group of master files used by the user terminals are connected, may comprise: a group of center master files at the master administration center which are kept updated to be the latest master file group; a user management file at the master administration center for managing information related to the users receiving the master file distribution service; a user's registration controlling means at the master administration center for registering subscriber's registration information in the user management file based on an application for a subscriber's registration from the user terminal and for distributing a master distributed-side program and a version mismatch checking program to the user terminal to be installed in the user terminal; an updating information providing means at the master administration center for providing information that updating has taken place to the user receiving the service whenever a master file in the center master file group is updated; the version mismatch checking program at the user terminal which, upon data exchange with other user terminal (e.g., upon data exchange for business transaction), raises an alarm when it detects any master file of an old version in its master file group; a master distributed-side program at the user terminal, which is activated in response to an updating request from the user who judges based on the information given by the updating information providing means and the alarm raised by the version mismatch checking program, which acquires versions of all of the master files in the master file group of the user terminal, which notifies the master administration center the version information, which updates the master file group of the user terminal by expanding compressed file data sent from the master administration center in response to the notice, and which sends an updating complete notice to the master administration center as soon as the updating is complete; and a master file distribution controlling means at the master administration center, which extracts a master file in the center master file group whose version mismatches with that of the corresponding master file in the master file group of the user terminal based on the version information sent from the user terminal, which sends compressed file data of the extracted master file to the user terminal, and which registers distribution information and charge information in the user management file based on the updating complete notice from the user terminal.

Furthermore, the present invention may be realized as a method for distributing a master file in a network system where a group of user terminals that mutually exchange data based on master files and a master administration center for unitarily administering a group of master files used by the user terminals are connected, the method comprising: a first step where subscriber's registration information of a user is registered in a user management file of the master administration center based on an application for receiving the master file distribution service from the user terminal, an a master distributed-side program is distributed to and installed into the user terminal; a second step where the master administration center provides information that updating has taken place to the user receiving the service whenever a master file in a center master file group is updated; a third step where the master distributed-side program installed in the user terminal in the first step is activated in response to an updating request from the user who judges based on the information provided in the second step; a fourth step where the master distributed-side program activated in the third step is controlled to acquire versions of all of the master files in the master file group of the user terminal and to send the version information to the master administration center; a fifth step where a master file the center master file group whose version mismatches with that of the corresponding master file in the master file group of the user terminal is extracted based on the version information sent from the user terminal to the master administration center, and compressed file data of the extracted master file is sent from the master administration center to the user terminal; a sixth step where the master file group of the user terminal is updated with the expanded data of the compressed file data sent from the master administration center in the fifth step, and an updating complete notice is sent from the user terminal to the master administration center upon completion of the updating: and a seventh step where distribution information and charge information are registered in the user management file of the master administration center based on the updating complete notice from the user terminal in the sixth step.

More generally, a system according to the present invention for distributing a master file in a network system where a group of user terminals that mutually exchange data based on master files and a master administration center for unitarily administering a group of master files used by the user terminals are connected, may comprise: a group of center master files at the master administration center which are kept updated to be the latest master file group; a user management file at the master administration center for managing information related to the users receiving the master file distribution service; a master distributing-side program at the master administration center for providing information that updating has taken place to the users receiving the distribution service whenever a master file in the center master file group is updated, for distributing data of the updated master file to the user terminal in need of the updated master file upon a request from the user, and for registering information in the user management file to automatically charge a service rate for the distribution; and the user terminal which updates its master file group with the data of the updated master file distributed by the master distributing-side program. The user terminal has a program, which checks, upon data exchange among the user terminals, whether any of the master files in its master file group is old, and announces a warning (a warning for the user to instruct an updating request) when it detects an old master file. For “distributing data of the updated master file”, the data may be compressed at and sent from the master administration center to the user terminal where the compressed data is expanded.

### BRIEF DESCRIPTION OF THE DRAWINGS

FIG. 1 is a block diagram showing a configuration of a master file distributing system according to a first embodiment of the invention;

FIG. 2 is a flowchart showing an operation for registering a subscriber to the distribution service according to the master file distribution system shown in FIG. 1, the figure also applies to an operation of a master file distributing method according to a second embodiment of the invention;

FIG. 3 is a flowchart showing an operation for providing master file updating information according to the master file distribution system shown in FIG. 1, the figure also applies to an operation of the master file distributing method according to the second embodiment of the invention;

FIG. 4 is a flowchart showing an operation for distributing a master file according to the master file distribution system shown in FIG. 1, the figure also applies to an operation of the master file distributing method according to the second embodiment of the invention;

FIG. 5 is a flowchart showing an operation for checking a version mismatch according to the master file distribution system shown in FIG. 1, the figure also applies to an operation of the master file distributing method according to the second embodiment of the invention; and

FIG. 6 is a block diagram showing a configuration of a master file distribution system according to a third embodiment of the invention.

### DETAILED DESCRIPTION OF THE INVENTION

Hereinafter, the present invention will be described in detail with reference to the drawings.

1. Embodiment 1

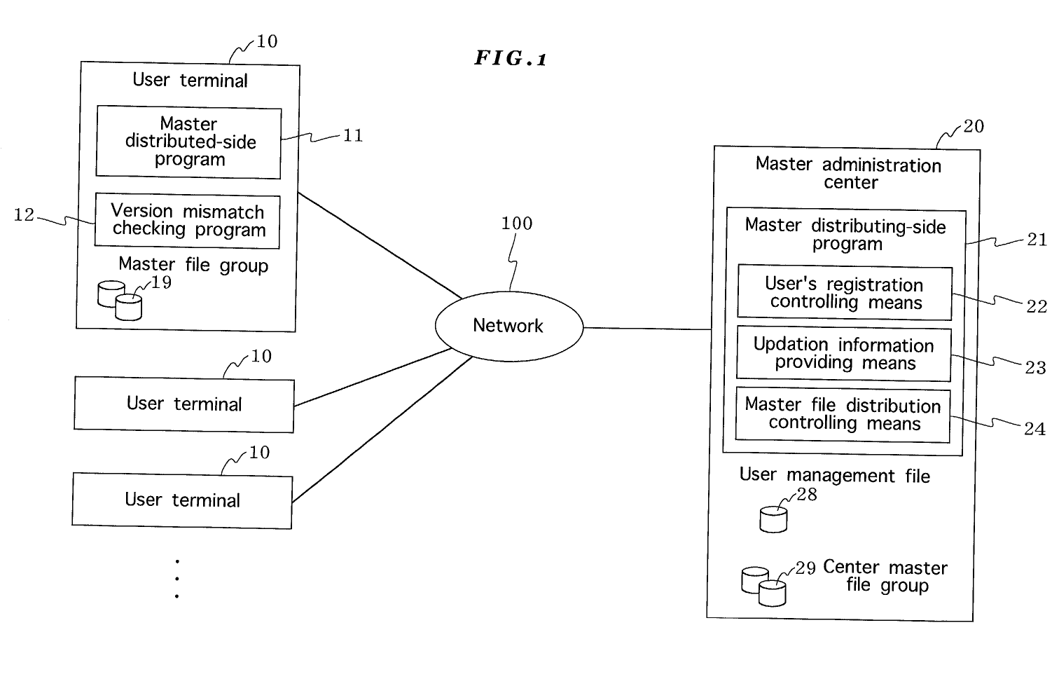

FIG. 1 is a block diagram showing a configuration of a system for distributing a master file according to a first embodiment of the invention.

Referring to FIG. 1, the master file distributing system of the present embodiment includes user terminals 10, a master administration center 20 and a communication network 100 such as the Internet that mutually connects the user terminals 10 with the master administration center 20.

The user terminal 10 is realized by a personal computer or the like which has a function of sending and receiving information to and from the master administration center 20 via the network 100.

The user terminal 10 is provided with a group of master files 19, and is able to run a master distributed-side control program 11 and a version mismatch checking program 12.

The master administration center 20 includes an information processor such as a workstation server, which has functions of sending/receiving information to/from the user terminal 10 via the network 100.

The master administration center 20 runs a master distributing-side program 21 for realizing the master file distributing service (a program for realizing a user's registration controlling means 22, an updating information providing means 23 and a master file distribution controlling means 24), stores a user management file 29 and administers a group of center master files 29. The master administration center 20 also controls the master distributed-side control program 11 and the version mismatch checking program 12.

The center master file group 29 is a group of master files in which attributes of data items, code information and the like used for exchanging data (e.g., upon transaction) between the users (e.g., companies) are defined. The master file group is kept updated to always be in the latest state (the master administration center 20 has a function of administering as well as a function of changing the center master file group 29).

The user management file 28 manages and stores information (subscriber's registration information, distribution information and charging information) relating to users who are receiving the master file distributing service (who are to be provided with the distributing service, or who has registered for the distributing service).

The master administration center 20 uses the master distributing-side program 21 to distribute an updated master file to the user terminal 10 (the user terminal 10 whose master distributed-side program 11 is active) via the network 100. Information relating to that distribution (distribution information) as well as charging information are registered in the user management file 28 so as to enable charging and collection of rates.

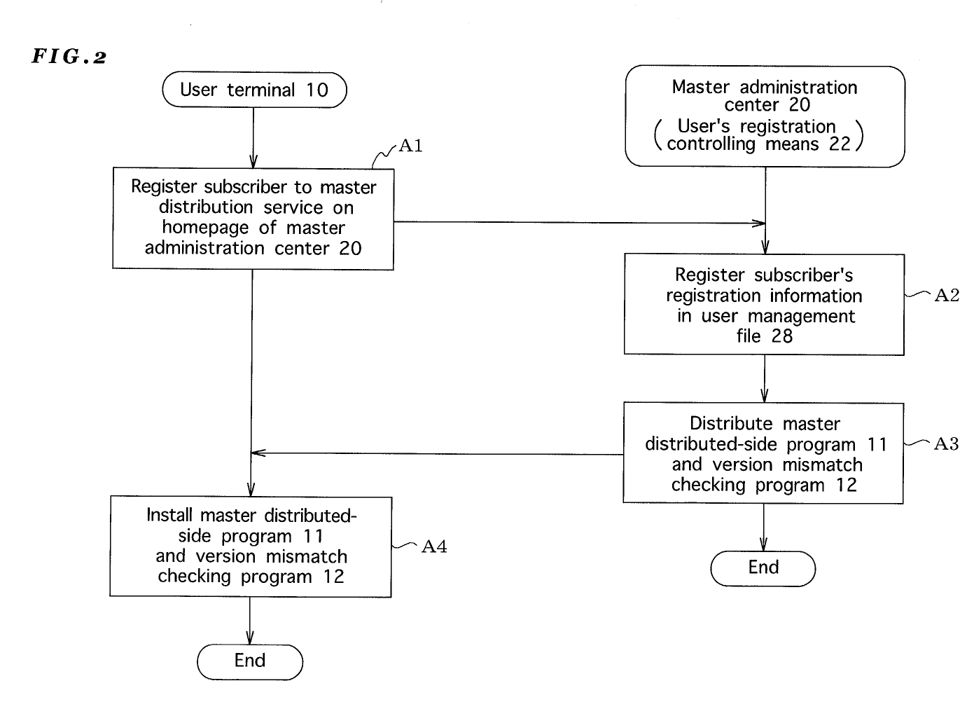

FIG. 2 is a flowchart showing an operation for registering distribution service subscribers according to the master file distributing system of the present embodiment. The operation includes Step A1 for applying for a subscriber's registration, Step A2 for registering subscriber's registration information, Step A3 for distributing programs and Step A4 for installing the programs.

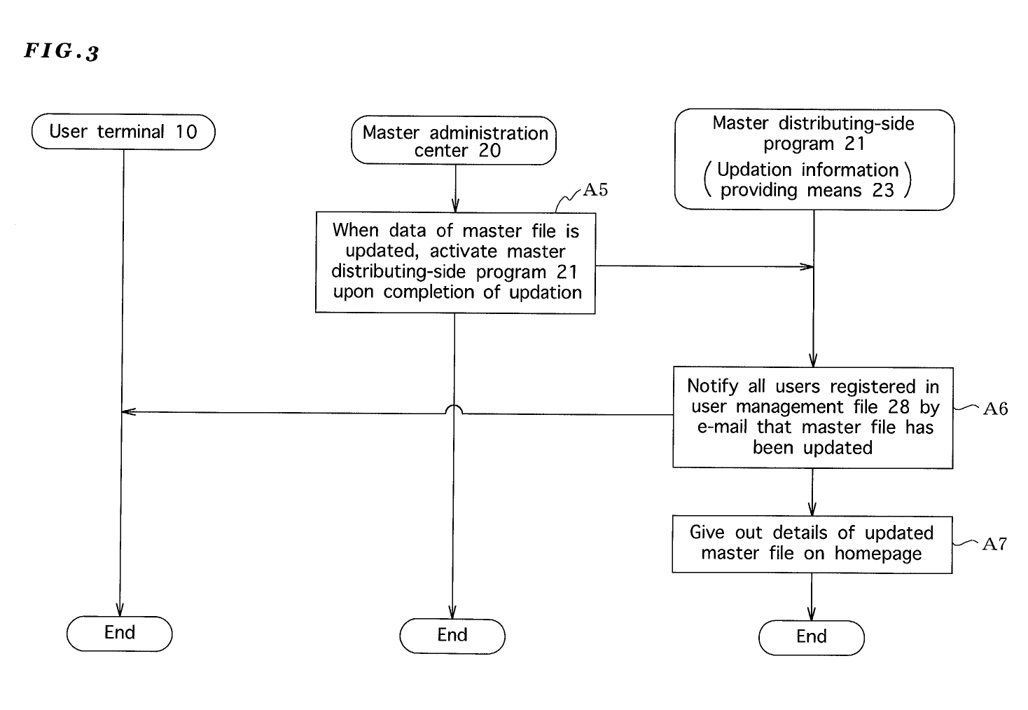

FIG. 3 is a flowchart showing an operation for providing master file update information according to the master file distributing system of the present embodiment. The operation includes Step A5 for activating the master distributing-side program, Step A6 for notifying by an electronic mail and Step A7 for disclosing on a homepage.

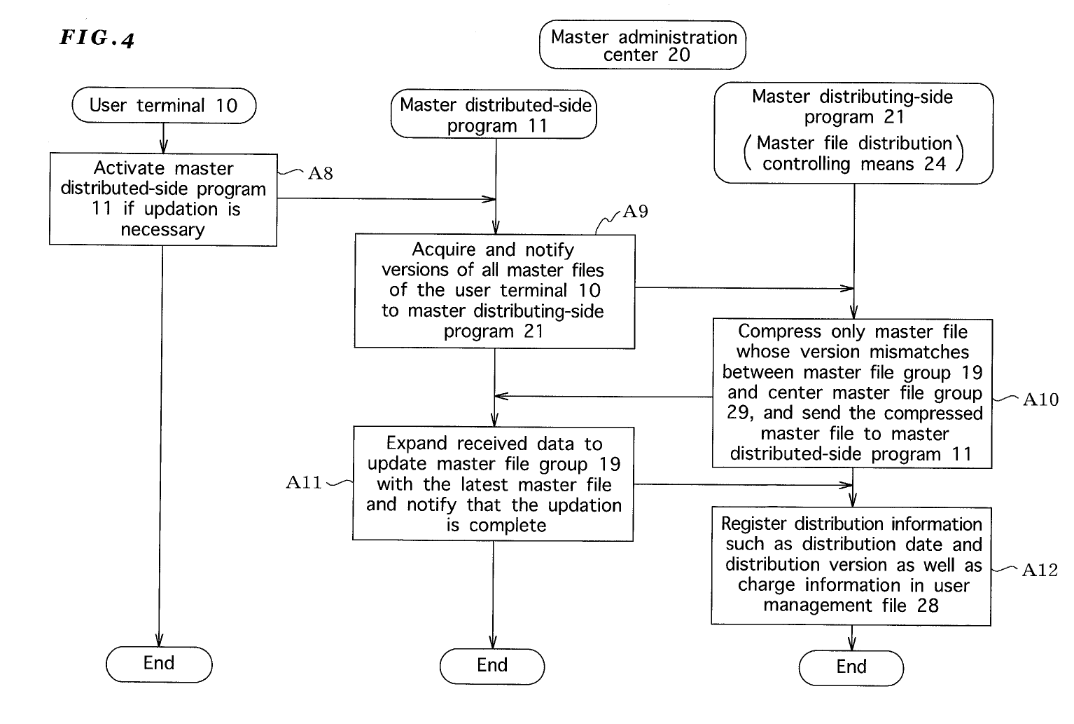

FIG. 4 is a flowchart showing an operation for distributing a master file according to the master file distributing system of the present embodiment. The operation includes Step A8 for activating the master distributing-side program, Step A9 for notifying version information, Step A10 for sending a version mismatch master file, Step A11 for updating a master file group and Step A12 for registering a distribution/charge information.

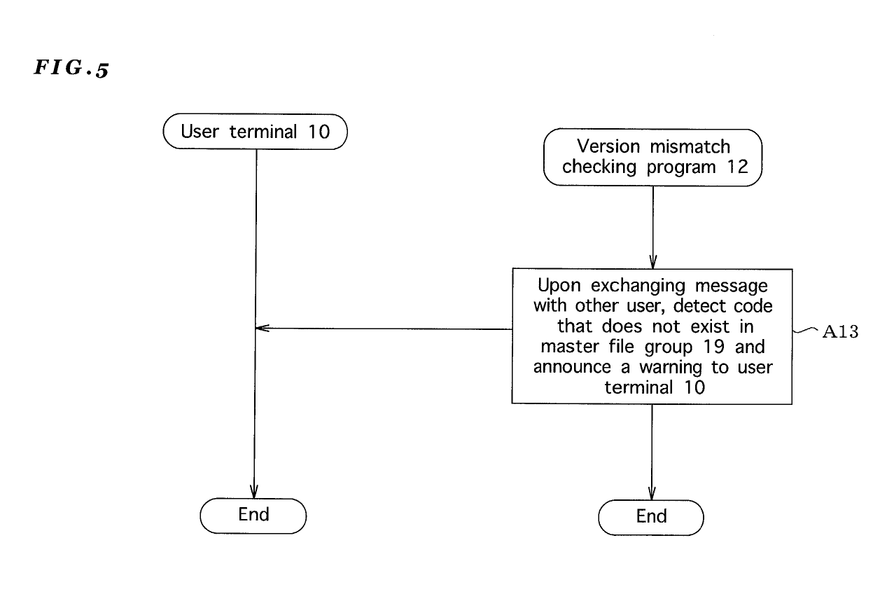

FIG. 5 is a flowchart showing an operation for checking version mismatches according to the master file distributing system of the present embodiment. The operation includes Step A13 for raising an alarm.

Hereinafter, the operations of the master file distributing system according to the present embodiment will be described with reference to FIGS. 1 to 5. Hereinafter, the network 100 refers to the Internet. In the following description, the network 100 is not specially mentioned although most of the sending/receiving operations are realized via the network 100.

The operation for registering a subscriber to the distribution service will be described (see FIG. 2).

First, a user who desires to receive the master file distribution service gives an instruction to the user terminal 10.

Based on the instruction, the user terminal 10 applies to the master administration center 20 for user's registration (subscriber's registration application). A master distributed-side program 11 for controlling master file distribution at the distributed-side (user terminal 10) as well as a version mismatch checking program 12 for announcing a warning (raising an alarm) to the user when any data item, code information or the like that is unregistered in the master file group 19 of the user terminal 10 is detected upon execution of data exchange between users (e.g., upon business transaction where one company receives a message from another company) are sent from the master administration center 20 to be installed into the user terminal 10.

Thus, the user terminal 10, based on the instruction from the user, makes access to a homepage for user's registration provided by the master administration center 20 and inputs necessary information (subscriber's registration information) to apply for the master file distribution service (master distribution service) (Step A1).

Upon receiving the subscriber's registration information input and sent from the user terminal 10 in Step A1, the user's registration controlling means 22 of the master administration center 20 (user's registration controlling means 22 in the master distributing-side program 21) registers the subscriber's registration information in the user management file 28 as information related to the user (Step A2).

The user's registration controlling means 22 distributes (sends), via the homepage or the like, the master distributed-side program 11 and the version mismatch checking program 12 necessary for the user to receive the distribution service (Step A3).

The user terminal 10 receives and installs these programs (the master distributed-side program 11 and the version mismatch checking program 12) (Step A4).

Secondly, the operation for providing master file updated information will be described (see FIG. 3).

When a master file in the center master file group 29 is updated at the master administration center 20, the master distributing-side program 21 is activated as soon as the updating of the master file is completed (Step A5).

The updating information providing means 23 of the master distributing-side program 21 searches in the user management file 28 to notify all of the user terminals 10 of the registered users (the subscribers to the master file distribution service) by an e-mail that the master file has been updated (Step A6).

In addition to the above-mentioned notice by e-mail, the updating information providing means 23 gives out details of the content of the updated master file on the homepage of the master administration center 20 (Step A7).

Thirdly, the operation for distributing the master file will be described (see FIG. 4).

Upon receiving the e-mail telling that the master file has been updated via the user terminal 10 (see Step A6 in FIG. 3), the user judges whether or not to update the master file group 19 in the user terminal 10 (e.g., based on the content of the updated master file given out on the homepage in Step A7 in FIG. 3). If the user judges to update the file group 19, the user instructs the master distributed-side program 11 to activate (Step A8).

The activated master distributed-side program 11 acquires the versions of all master files in the master file group 19 of the user terminal 10 and informs the version information indicating them to the master distributing-side program 21 of the master administration center 20 (Step A9). Then, the user is able to request the master administration center 20 to distribute the master file for updating.

Upon being informed in Step A9, the master file distribution controlling means 24 of the master distributing-side program 21 compares the version of each master file in the center master file group 29 of the master administration center 20 with the version of the corresponding master file in the master file group 19 specified in the received version information to select (extract) all of the master files whose versions are older in the user terminal 10, and generates and sends compressed file data of those master files in the center master file group 29 to the master distributed-side program 11 of the user terminal 10 (Step A10).

Upon receiving the compressed file data, the master distributed-side program 11 depresses (expands) the compressed data with which corresponding master files in the master file group 19 of the user terminal 10 are appropriately replaced (i.e., the master file group 19 are updated with the latest master files). Once the replacement (updating) is completed, this is informed (an updating complete notice) to the master distributing-side program 21 (Step A11).

When the master file distribution controlling means 24 in the master distributing-side program 21 receives this updating complete notice, it registers distribution information such as the date and version of the distribution as well as charge information in an user-assigned area of the user management file 28 (Step A12).

Based on the charge information registered in the user management file 28 as described above, the master distribution center 20 can automatically charge the service rate for distributing each master file to each service subscriber as well as manage rate collection based on the charge.

Alternatively, in “distributing data of updated master files” in Step A10, the data may not be compressed at the master administration center 20 (by the master distributing-side program 21) so that data expansion by the user terminal 10 (the master distributed-side program 11) is unnecessary in Step A11.

Fourthly, the operation for checking version mismatch will be described (see FIG. 5).

The version mismatch checking program 12 which is continuously run on the user terminal 10 analyzes (checks) the received data whenever it receives data (message) from other company or the like upon data exchange between the users (transaction between companies).

When it detects that “a data item or a code contained in the received data does not exist in the master file group 19 of the user terminal 10”, it displays (announces) so on the user terminal 10 as an alarm to warn the user that the master file group 19 may possibly be old (Step A13).

By this warning, the user judges the necessity of updating the master file group 19 of the user terminal 10. When the user judges that updating is necessary, processes following Step A8 (“activating master distributed-side program 11”) are carried out.

Even when the version mismatch checking program 12 does not exist, the master file distribution system of the invention can be realized. In this case, the operation relating to the version mismatch checking program 12 in Steps A3 and A4 shown in FIG. 2 as well as the operation shown in FIG. 5 are omitted.

2. Embodiment 2

Hereinafter, a method for distributing a master file according to a second embodiment of the invention will be described.

The method according to the present embodiment for distributing a master file in a network system where a group of user terminals that mutually exchange data based on master files and a master administration center for unitarily administering a group of master files used by the user terminals are connected, comprises: a first step where subscriber's registration information of a user is registered in a user management file of the master administration center based on an application for receiving the master file distribution service from the user terminal, and a master distributed-side program and a version mismatch checking program are distributed to and installed into the user terminal; a second step where the master administration center provides information that updating has taken place to the user receiving the service whenever a master file in a center master file group is updated; a third step where the master distributed-side program installed in the user terminal in the first step is activated in response to an updating request from the user who judges based on the information provided in the second step and an alarm in the eighth step; a fourth step where the master distributed-side program activated in the third step is controlled to acquire versions of all of the master files in the master file group of the user terminal and to send the version information to the master administration center; a fifth step where a master file in the center master file group whose version mismatches with that of the corresponding master file in the master file group of the user terminal is extracted based on the version information sent from the user terminal to the master administration center, and compressed file data of the extracted master file is sent from the master administration center to the user terminal; a sixth step where the master file group of the user terminal is updated with the expanded data of the compressed file data sent from the master administration center in the fifth step, and an updating complete notice is sent from the user terminal to the master administration center upon completion of the updating: a seventh step where distribution information and charge information are registered in the user management file of the master administration center based on the updating complete notice from the user terminal in the sixth step; and an eighth step where the version mismatch checking program installed in the first step is activated on the user terminal to raise an alarm when it detects any master file of an old version in its master file group upon data exchange with other user terminal.

The flowcharts shown in FIGS. 2 to 5 also apply to operations of the master file distributing method according to the second embodiment of the invention.

Specifically, the above-mentioned first step corresponds to Steps A1 to A4 in FIG. 2, the second step to Steps A5 to A7 in FIG. 3, the third step to Step A8 in FIG. 4, the fourth step to Step A9, the fifth step to Step A10, the sixth step to Step A11, the seventh step to Step A12, and the eighth step to Step A13 in FIG. 5.

The operations (processes) of the master file distributing method of the present embodiment are the same as those shown in FIGS. 2 to 5 which are described above for the master file distributing system according to the first embodiment of the invention.

The master file distributing method of the invention can still be realized even if the operation relating to the version mismatch checking program 12 in Steps A3 and A4 in FIG. 2 as well as the operation shown in FIG. 5 (Step A13) are omitted,.

In distributing data of the updated master file, the data may not be compressed at the master administration center 20 in the fifth step so that data expansion at the user terminal 10 in the sixth step is unnecessary.

3. Embodiment 3

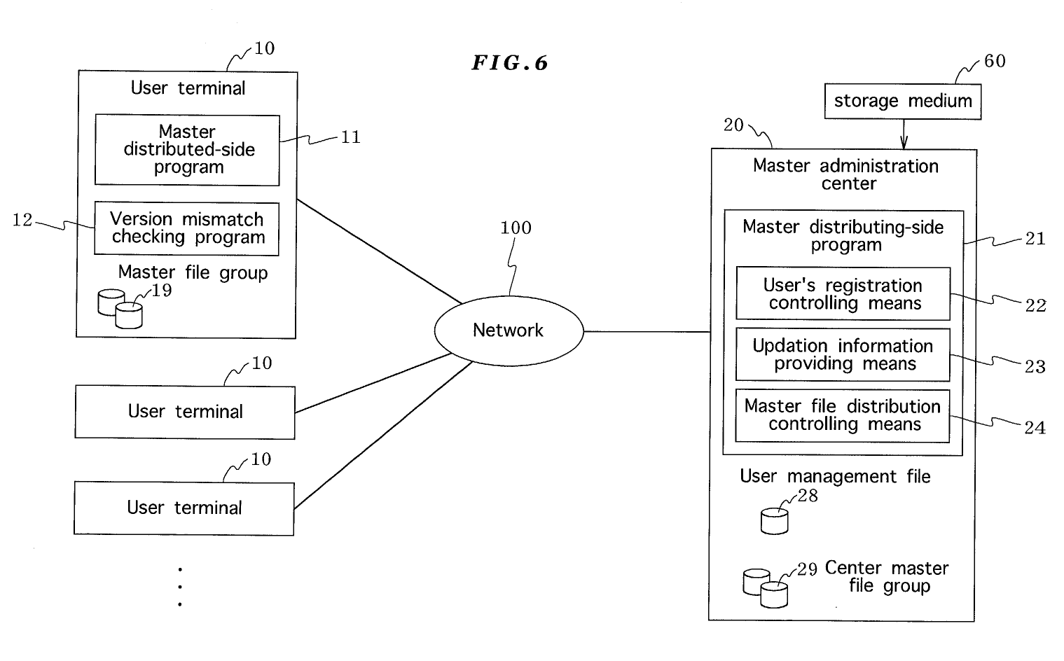

FIG. 6 is a block diagram showing a configuration of a system for distributing a master file according to a third embodiment of the present invention.

Referring to FIG. 6, the master file distributing system according to the third embodiment of the invention differs from the system according to the first embodiment shown in FIG. 1 in that it is provided with a storage medium 60 for storing the master distributing-side program 21. The storage medium 60 may be a magnetic disk, a semiconductor memory or other storage medium.

The master distributing-side program 21 is read from the storage medium 60 by the master administration center 20 to control the operations of the master administration center 20, as the user registering means 22, the updating information providing means 23 and the master file distribution controlling means 24. The operations of the master administration center 20 controlled by the master distributing-side program 21 (operations by the user registering means 22, the updating information providing means 23 and the master file distribution controlling means 24) are the same as those of the master administration center 20 (operations by the user registering means 22, the updating information providing means 23 and the master file distribution controlling means 24) according to the first embodiment of the invention. Thus, the details of these operations are omitted.

Thus, the present invention has the following advantages.

Firstly, the master file group (center master file group) is unitarily administered by the master administration center (centralized administration) so that whenever a master file is updated, information of the updating is notified to the users at an appropriate timing via some media such as an e-mail and a homepage. Since the user can update the master files only for those relative to the user, even if updating takes place for several times a day, the user can judge the timing of the file to be transferred so that the master file can be transferred (distributed) at a minimum transfer amount without unconditionally transferring the files every time updating takes place.

Secondly, the program for controlling the master file distribution (the master distributed-side program) is distributed to the user terminal so that versions of the master files of the user terminal can be acquired and thus only necessary master files can be distributed. By providing file compression/expansion functions, the master file can be transferred at a minimum transfer amount, thereby reducing charged usage of line upon transferring the file.

Thirdly, by installing the version mismatch checking program, when only master file of the user is detected to be old upon receiving data from other company while data exchange for transaction is actually taking place between the companies, it can be prevented from ignoring to update the master file. Thus, trouble upon transaction with other companies can be prevented.

Fourthly, for the master file distribution having the above-described advantages, the provider of the distribution service can appropriately charge and collect rate from the users using the service (service subscribers) based on the user management file (an appropriate service rate can automatically be charged whenever the user uses the distribution service).

In view of the recent increase of the occasion of EC (Electric Commerce) using RosettaNet or the like, where various code files and control data are updated daily and where realtime distribution to multiple companies is expected to increase, the present invention having the above-described advantages is highly useful for placing the master file distribution service into business.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-329983 (Filed on Oct. 30, 2000) including specification, claims, drawings and summary are incorporated herein by reference in its entirety.

What is to be claimed:

1. A system for distributing a master file in a network system where a group of user terminals that mutually exchange data based on master files and a master administration center for unitarily administering a group of master files used by the user terminals are connected, the system comprising:
a group of center master files at the master administration center which are kept updated to be the latest master file group;
a user management file at the master administration center for managing information related to the users receiving the master file distribution service;
a master distributing-side program at the master administration center for providing information that the master files are updated to the users receiving the distribution service whenever a master file in the center master file group is updated, for distributing data of the updated master file to the user terminal in need of the updated master file upon a request from the user, and for registering information in the user management file to automatically charge a service rate for the distribution; and
the user terminal which updates its master file group with the data of the updated master file distributed by the master distributing-side program.

2. A master file distributing system according to claim 1, wherein the user terminal has a program which checks, upon data exchange among the user terminals, whether any of the master files in its master file group is old, and announces a warning when it detects an old master file.

3. A master file distributing system according to claim 1, wherein, for distributing data of the updated master file, the data is compressed at and sent from the master administration center to the user terminal where the compressed data is expanded.

4. A system for distributing a master file in a network system where a group of user terminals that mutually exchange data based on master files and a master administration center for unitarily administering a group of master files used by the user terminals are connected, the system comprising:
a group of center master files at the master administration center which are kept updated to be the latest master file group;
a user management file at the master administration center for managing information related to the users receiving the master file distribution service;
a user's registration controlling means at the master administration center for registering subscriber's registration information in the user management file based on an application for a subscriber's registration from the user terminal and for distributing a master distributed-side program to the user terminal to be installed in the user terminal;
an updating information providing means at the master administration center for providing information that the master files are updated to the user receiving the service whenever a master file in the center master file group is updated;
a master distributed-side program at the user terminal, which is activated in response to an updating request from the user who judges based on the information given by the updating information providing means, which acquires versions of all of the master files in the master file group of the user terminal, which notifies the master administration center the version information, which updates the master file group of the user terminal by expanding compressed file data sent from the master administration center in response to the notice, and which sends an updating complete notice to the master administration center as soon as the updating is complete; and
a master file distribution controlling means at the master administration center, which extracts a master file in the center master file group whose version mismatches with that of the corresponding master file in the master file group of the user terminal based on the version information sent from the user terminal, which sends compressed file data of the extracted master file to the user terminal, and which registers distribution information and charge information in the user management file based on the updating complete notice from the user terminal.

5. A system for distributing a master file in a network system where a group of user terminals that mutually exchange data based on master files and a master administration center for unitarily administering a group of master files used by the user terminals are connected, the system comprising:
a group of center master files at the master administration center which are kept updated to be the latest master file group;
a user management file at the master administration center for managing information related to the users receiving the master file distribution service;
a user's registration controlling means at the master administration center for registering subscriber's registration information in the user management file based on an application for a subscriber's registration from the user terminal and for distributing a master distributed-side program and a version mismatch checking program to the user terminal to be installed in the user terminal;
an updating information providing means at the master administration center for providing information that the master files are updated to the user receiving the service whenever a master file in the center master file group is updated;
the version mismatch checking program at the user terminal which, upon data exchange with other user terminal, raises an alarm when it detects any master file of an old version in its master file group;
a master distributed-side program at the user terminal, which is activated in response to an updating request from the user who judges based on the information given by the updating information providing means and the alarm raised by the version mismatch checking program, which acquires versions of all of the master files in the master file group of the user terminal, which notifies the master administration center the version information, which updates the master file group of the user terminal by expanding compressed file data sent from the master administration center in response to the notice, and which sends an updating complete notice to the master administration center as soon as the updating is complete; and
a master file distribution controlling means at the master administration center, which extracts a master file in the center master file group whose version mismatches with that of the corresponding master file in the master file group of the user terminal based on the version information sent from the user terminal, which sends compressed file data of the extracted master file to the user terminal, and which registers distribution information and charge information in the user management file based on the updating complete notice from the user terminal.

6. A system for distributing a master file according to claim 4, wherein the updating information is provided to the user terminal by means of an electronic mail sent by the updating information providing means of the master administration center and by means of a homepage.

7. A method for distributing a master file in a network system where a group of user terminals that mutually exchange data based on master files and a master administration center for unitarily administering a group of master files used by the user terminals are connected, the method comprising:
a first step where subscriber's registration information of a user is registered in a user management file of the master administration center based on an application for receiving the master file distribution service from the user terminal, an a master distributed-side program is distributed to and installed into the user terminal;
a second step where the master administration center provides information that updating has taken place to the user receiving the service whenever a master file in a center master file group is updated;
a third step where the master distributed-side program installed in the user terminal in the first step is activated in response to an updating request from the user who judges based on the information provided in the second step;
a fourth step where the master distributed-side program activated in the third step is controlled to acquire versions of all of the master files in the master file group of the user terminal and to send the version information to the master administration center;
a fifth step where a master file the center master file group whose version mismatches with that of the corresponding master file in the master file group of the user terminal is extracted based on the version information sent from the user terminal to the master administration center, and compressed file data of the extracted master file is sent from the master administration center to the user terminal;
a sixth step where the master file group of the user terminal is updated with the expanded data of the compressed file data sent from the master administration center in the fifth step, and an updating complete notice is sent from the user terminal to the master administration center upon completion of the updating: and
a seventh step where distribution information and charge information are registered in the user management file of the master administration center based on the updating complete notice from the user terminal in the sixth step.

8. A method for distributing a master file in a network system where a group of user terminals that mutually exchange data based on master files and a master administration center for unitarily administering a group of master files used by the user terminals are connected, the method comprising:
a first step where subscriber's registration information of a user is registered in a user management file of the master administration center based on an application for receiving the master file distribution service from the user terminal, and a master distributed-side program and a version mismatch checking program are distributed to and installed into the user terminal;
a second step where the master administration center provides information that updating has taken place to the user receiving the service whenever a master file in a center master file group is updated;
a third step where the master distributed-side program installed in the user terminal in the first step is activated in response to an updating request from the user who judges based on the information provided in the second step and an alarm in the eighth step;
a fourth step where the master distributed-side program activated in the third step is controlled to acquire versions of all of the master files in the master file group of the user terminal and to send the version information to the master administration center;
a fifth step where a master file in the center master file group whose version mismatches with that of the corresponding master file in the master file group of the user terminal is extracted based on the version information sent from the user terminal to the master administration center, and compressed file data of the extracted master file is sent from the master administration center to the user terminal;
a sixth step where the master file group of the user terminal is updated with the expanded data of the compressed file data sent from the master administration center in the fifth step, and an updating complete notice is sent from the user terminal to the master administration center upon completion of the updating:
a seventh step where distribution information and charge information are registered in the user management file of the master administration center based on the updating complete notice from the user terminal in the sixth step; and
an eighth step where the version mismatch checking program installed in the first step is activated on the user terminal to raise an alarm when it detects any master file of an old version in its master file group upon data exchange with other user terminal.

9. A method for distributing a master file according to claim 7, wherein, in the second step, the updating information is provided by the master administration center to the user terminal by means of an electronic mail and by means of a homepage.

10. A storage medium used in a network system where a group of user terminals that mutually exchange data based on master files and a master administration center for unitarily administering a group of master files used by the user terminals are connected, the system comprising: a group of center master files at the master administration center which are kept updated to be the latest master file group; and a user management file at the master administration center for managing information related to the users receiving the master file distribution service,
wherein, the storage medium stores a master distributing-side program for controlling the master administration center to function as:
a user's registration controlling means for registering subscriber's registration information of a user in the user management file based on an application for receiving the master file distribution service from the user terminal, and for distributing a master distributed-side program to be installed in the user terminal, the master distributed-side program being activated in response to an updating request from the user who judges based on the information given by an updating information providing means, acquiring versions of all of the master files in the master file group of the user terminal, sending the version information to the master administration center, updating the master file group of the user terminal by expanding compressed file data from the master administration center sent in response to the notice, and sending an updating complete notice to the master administration center as soon as the updating is complete;
the updating information providing means for providing information that updating has taken place to the user receiving the service whenever a master file in the center master file group is updated; and
a master file distribution controlling means for extracting a master file in the center master file group whose version mismatches with that of the corresponding master file in the master file group of the user terminal based on the version information sent from the user terminal, for sending compressed file data of the extracted master file to the user terminal, and for registering distribution information and charge information in the user management file based on the updating complete notice from the user terminal.

11. A storage medium used in a network system where a group of user terminals that mutually exchange data based on master files and a master administration center for unitarily administering a group of master files used by the user terminals are connected, the system comprising: a group of center master files at the master administration center which are kept updated to be the latest master file group; and a user management file at the master administration center for managing information related to the users receiving the master file distribution service,
wherein, the storage medium stores a master distributioning-side program for controlling the master administration center to function as:
a user's registration controlling means for registering subscriber's registration information of a user in the user management file based on an application for receiving the master file distribution service from the user terminal, and for distributing a master distributed-side program and a version mismatch checking program to be installed in the user terminal, the master distributed-side program being activated in response to an updating request from the user who judges based on the information given by an updating information providing means and the alarm by a version mismatch checking program, acquiring versions of all of the master files in the master file group of the user terminal, sending the version information to the master administration center, updating the master file group of the user terminal by expanding compressed file data from the master administration center sent in response to the notice, and sending an updating complete notice to the master administration center as soon as the updating is complete, while the version mismatch checking program raising an alarm when it detects any master file of an old version in the master file group of its user terminal upon data exchange with other user terminal;
the updating information providing means for providing information that updating has taken place to the user receiving the service whenever a master file in the center master file group is updated; and
a master file distribution controlling means for extracting a master file in the center master file group whose version mismatches with that of the corresponding master file in the master file group of the user terminal based on the version information sent from the user terminal, for sending compressed file data of the extracted master file to the user terminal, and for registering distribution information and charge information in the user management file based on the updating complete notice from the user terminal.

12. A system for distributing a master file according to claim 4, wherein, for distributing data of an updated master file, the data is sent to the user terminal without being compressed at the master administration center so that the data is not expanded at the user terminal.

13. A method for distributing a master file according to claim 7, wherein, for distributing data of an updated master file, the data is sent to the user terminal without being compressed at the master administration center so that the data is not expanded at the user terminal.

14. A storage medium according to claim 10, wherein for distributing data of an updated master file by the master distributing-side program stored in the storage medium, the data is sent to the user terminal without being compressed at the master administration center so that the data is not expanded at the user terminal
